(19) United States
(12) Patent Application Publication
(10) Pub. No.: US 2021/0331547 A1
(43) Pub. Date: Oct. 28, 2021

(54) Device, System and Method for Controlling Active Suspension

(71) Applicant: Guangzhou Automobile Group Co., Ltd., Guangzhou, Guangdong (CN)

(72) Inventors: Bo YANG, Guangzhou, Guangdong (CN); Shaotang HUANG, Guangzhou, Guangdong (CN); Ying ZHANG, Guangzhou, Guangdong (CN); Zhide ZHANG, Guangzhou, Guangdong (CN); Congchuan CHEN, Guangzhou, Guangdong (CN)

(21) Appl. No.: 16/319,360

(22) PCT Filed: Jul. 17, 2018
(86) PCT No.: PCT/CN2018/096024

§ 371 Date: Jan. 21, 2019

(30) Foreign Application Priority Data
Dec. 6, 2017 (CN) 201711279453.2

(51) Int. Cl. B60G 17/0165; B60G 17/019

(52) U.S. Cl. CPC B60G 17/0165; B60G 2401/00; B60G 17/01908

(57) ABSTRACT

A device, system and method for controlling an active suspension are provided. The device includes: a Micro Control Unit (MCU), an ultrasonic sensor, a vehicle wheel longitudinal acceleration sensor, and a vehicle body longitudinal acceleration sensor. The vehicle wheel longitudinal acceleration sensor acquires a vehicle wheel longitudinal acceleration signal and transmits it to the MCU. The vehicle body longitudinal acceleration sensor acquires a vehicle body longitudinal acceleration signal and transmits it to the MCU. The ultrasonic sensor excites an ultrasonic wave according to a set angle, and transmits a received echo signal to the MCU. The MCU calculates a reference current I of a shock absorber according to the echo signal, calculates a target current I′ of the shock absorber according to the vehicle wheel longitudinal acceleration signal and the vehicle body longitudinal acceleration signal, and regulates an input current of the shock absorber according to the reference current I and the target current I′.

The present application claims priority to Chinese Patent Application No. 201711279453.2, entitled “Device, System and Method for Controlling Active Suspension” filed on Dec. 6, 2017, which is incorporated by reference in its entirety.

### TECHNICAL FIELD

The present disclosure relates to the technical field of automobiles, and in particular to a device, system and method for controlling an active suspension.

### BACKGROUND

With the rapid development of vehicle industry, a person has increasingly higher requirements on vehicle's comfortableness of driving. When a vehicle passes by a bumpy section of road, a shock absorber is able to effectively reduce shock impulses in the vehicle. However, an effective prejudgment cannot be made during the adjustment of the shock absorber, which causes a delay on the control over the shock absorber. As a result, a driver feels bumps inevitably, and the comfortableness of driving is influenced greatly.

At present, a suspension system of the vehicle includes a passive suspension and an active suspension. For the passive suspension, damping and height of the shock absorber has been fixed before delivery, and the damping and height of the shock absorber cannot be regulated. For the active suspension, the damping and height of the suspension may be regulated in real time according to road conditions, that is, when the vehicle passes by a bumpy section of road, the damping is reduced, and the height is regulated, so as to make the vehicle smooth. However, a control method adopted by the active suspension is mostly PI regulation or improved PI regulation, and the road condition may be detected only after the vehicle has reached the bumpy section, and then the damping and height are regulated. As a result, there is a lag existing in the current PI regulation of the active suspension, and the driver and passenger in the vehicle are still subjected to bumps inevitably.

### SUMMARY

The technical problem to be solved by the embodiments of the present disclosure is to provide a device, system and method for controlling an active suspension, so as to prejudge a road condition ahead, automatically control a shock absorber, and adjust in advance a control current output to the shock absorber to make the control current reach a target current, thereby reducing the shock impulses in a vehicle when the vehicle goes through a bumpy section of road ahead, and improving comfortableness and stationarity of driving and riding.

In order to solve the above technical problem, some embodiments of the present disclosure provide a method for controlling an active suspension, which includes the following operations.

An ultrasonic sensor is controlled to excite an ultrasonic wave according to a set angle, and receive an echo signal transmitted by the ultrasonic sensor, herein the set angle changes continuously.

A vehicle wheel longitudinal acceleration signal transmitted by a vehicle wheel longitudinal acceleration sensor and a vehicle body longitudinal acceleration signal transmitted by a vehicle body longitudinal acceleration sensor are received.

A reference current I of a shock absorber is calculated according to the echo signal transmitted by the ultrasonic sensor, a target current I′ of the shock absorber is calculated according to the vehicle wheel longitudinal acceleration signal and the vehicle body longitudinal acceleration signal, and an input current of the shock absorber is regulated according to the reference current I and the target current I′.

In an exemplary embodiment, the operation that the reference current I of the shock absorber is calculated according to the echo signal transmitted by the ultrasonic sensor includes:

a depth of a depression or a height of a slope in front of a vehicle wheel in a driving direction of a vehicle is calculated according to the echo signal, and then the reference current I is calculated according to the depth of the depression or the height of the slope in front of the vehicle wheel and the time t needed by the vehicle wheel to reach the depression or the slope in front of the vehicle wheel.

The operations that the target current I′ of the shock absorber is calculated according to the vehicle wheel longitudinal acceleration signal and the vehicle body longitudinal acceleration signal, and the input current of the shock absorber is regulated according to the reference current I and the target current I′ include:

a vehicle wheel longitudinal acceleration and a vehicle body longitudinal acceleration are obtained according to the vehicle wheel longitudinal acceleration signal and the vehicle body longitudinal acceleration signal, the target current I′ is calculated according to the vehicle wheel longitudinal acceleration and the vehicle body longitudinal acceleration, and a PI control algorithm is used to regulate the input current of the shock absorber according to the target current I′ and the reference current I, so as to regulate damping of the shock absorber.

In an exemplary embodiment, the operation that the PI control algorithm is used to regulate the input current of the shock absorber includes:

a current error is calculated according to the target current I′ and a control current output to the shock absorber (6); the PI control algorithm is used to obtain a duty ratio according to the current error and the reference current I; a corresponding pulse signal is output to an H-bridge module according to the duty ratio to control the H-bridge module to generate a corresponding control current; and the control current is transported to the shock absorber.

In an exemplary embodiment, the reference current I is calculated according to the following formula:

I=K1*h*|H|/t;

where K1 is a set coefficient, and 0<K1*h/t<20; and h is a height of a vehicle body.

A Micro Control Unit (MCU) calculates the target current I′ according to the following formula:

I′=K2*Vb/(Vb−Vw);

where K2 is a scalar coefficient, and 0<K2<30; Vb is a longitudinal velocity of the vehicle body; Vw is a longitudinal velocity of a vehicle wheel; the Vb and the Vw are obtained by performing differentiation processing according to the vehicle body longitudinal acceleration and the vehicle wheel longitudinal acceleration.

In an exemplary embodiment, the MCU calculates the duty ratio according to the following formula:

PWM=Kp*(ΔI−ΔI′)+Ki*ΔI+I+PWM′;

where Kp is a proportionality coefficient, Ki is a differential coefficient, ΔI is the current error of a latter moment in adjacent two moments, ΔI′ is the current error of a previous moment in adjacent two moments, PWM is the duty ratio of the latter moment in adjacent two moments, PWM′ is the duty ratio of the previous moment in adjacent two moments, and 1<Kp<50, 0<Ki<0.5, and the duty ratio of an initial moment is 0.

Some embodiments of the present disclosure provide a device for controlling an active suspension, which includes: an MCU, an ultrasonic sensor, a vehicle wheel longitudinal acceleration sensor and a vehicle body longitudinal acceleration sensor.

The vehicle wheel longitudinal acceleration sensor is configured to acquire a vehicle wheel longitudinal acceleration signal, and transmit the vehicle wheel longitudinal acceleration signal to the MCU.

The vehicle body longitudinal acceleration sensor is configured to acquire a vehicle body longitudinal acceleration signal, and transmit the vehicle body longitudinal acceleration signal to the MCU.

The ultrasonic sensor is set on a vehicle head in front of vehicle wheels, and is configured to excite an ultrasonic wave according to a set angle, and transmit a received echo signal to the MCU.

The MCU is electrically connected with each of the plurality of shock absorbers which is set between the vehicle wheel and the respective vehicle body, and is configured to calculate a reference current I of the shock absorber according to the echo signal, calculate a target current I′ of the shock absorber according to the vehicle wheel longitudinal acceleration signal and the vehicle body longitudinal acceleration signal, and regulate an input current of the shock absorber according to the reference current I and the target current I′.

In an exemplary embodiment, the MCU is configured to calculate, according to the echo signal, a depth of a depression or a height of a slope in front of the vehicle wheel in a driving direction of a vehicle, and then calculate the reference current I according to the depth of the depression or the height of the slope in front of the vehicle wheel and the time t needed by the vehicle wheel to reach the depression or the slope in front of the vehicle wheel. The MCU is further configured to obtain a vehicle wheel longitudinal acceleration and a vehicle body longitudinal acceleration according to the vehicle wheel longitudinal acceleration signal and the vehicle body longitudinal acceleration signal, calculate the target current I′ according to the vehicle wheel longitudinal acceleration and the vehicle body longitudinal acceleration, and use a PI control algorithm to regulate the input current of the shock absorber according to the target current I′ and the reference current I, so as to regulate damping of the shock absorber.

The MCU is further configured to output a control instruction to the ultrasonic sensor, so as to control the set angle, according to which the ultrasonic sensor excites the ultrasonic wave, to change continuously.

The ultrasonic sensor is a phased array ultrasonic sensor.

In an exemplary embodiment, the device further includes an H-bridge module.

The H-bridge module is configured to generate a corresponding control current according to a pulse signal from the MCU, and transport the control current to the shock absorber, so as to regulate damping of the shock absorber.

The MCU is configured to calculate a current error according to the target current I′ and the control current, use the PI control algorithm to obtain a duty ratio according to the current error and the reference current I, and output a corresponding pulse signal to the H-bridge module according to the duty ratio.

In an exemplary embodiment, the device further includes a resistor and a voltage acquisition device.

The resistor is connected between an output end of the H-bridge module and the shock absorber in series.

The voltage acquisition device is connected to two ends of the resistor in parallel, is electrically connected with the MCU, and is configured to acquire voltage signals of the two ends of the resistor, and transmit the voltage signals to the MCU.

The MCU is further configured to calculate the control current according to the voltage signals and a resistance value of the resistor.

In an exemplary embodiment, the MCU is configured to calculate the reference current I according to the following formula:

I=K1*h*|H|/t;

where K1 is a set coefficient, and 0<K1*h/t<20; and h is a height of a vehicle body.

In an exemplary embodiment, the MCU is configured to calculate the target current I′ according to the following formula:

I′=K2*Vb/(Vb−Vw);

where K2 is a scalar coefficient, and 0<K2<30; Vb is a longitudinal velocity of the vehicle body; Vw is a longitudinal velocity of a vehicle wheel; the Vb and the Vw are obtained by performing differentiation processing according to the vehicle body longitudinal acceleration and the vehicle wheel longitudinal acceleration.

In an exemplary embodiment, the MCU is configured to calculate the duty ratio according to the following formula:

PWM=Kp*(ΔI−ΔI′)+Ki*ΔI+I+PWM′;

where Kp is a proportionality coefficient, Ki is a differential coefficient, ΔI is the current error of a latter moment in adjacent two moments, ΔI′ is the current error of a previous moment in adjacent two moments, PWM is the duty ratio of the latter moment in adjacent two moments, PWM′ is the duty ratio of the previous moment in adjacent two moments, and 1<Kp<50, 0<Ki<0.5, and the duty ratio of an initial moment is 0.

Some embodiments of the present disclosure provide a system for controlling an active suspension, which includes: a device for controlling the active suspension and a plurality of shock absorbers electrically connected with the device for controlling the active suspension. Each of the plurality of shock absorbers is set between a vehicle body and a respective vehicle wheel.

The device for controlling the active suspension includes: the MCU, the ultrasonic sensor, the vehicle wheel longitudinal acceleration sensor and the vehicle body longitudinal acceleration sensor.

The vehicle wheel longitudinal acceleration sensor is configured to acquire a vehicle wheel longitudinal acceleration signal, and transmit the vehicle wheel longitudinal acceleration signal to the MCU.

The vehicle body longitudinal acceleration sensor is configured to acquire a vehicle body longitudinal acceleration signal, and transmit the vehicle body longitudinal acceleration signal to the MCU.

The ultrasonic sensor is set on the vehicle head in front of vehicle wheels, and is configured to excite the ultrasonic wave according to the set angle, and transmit the received echo signal to the MCU.

The MCU is electrically connected with each of the plurality of shock absorbers which is set between the vehicle wheel and the respective vehicle body, and is configured to calculate a reference current I of a respective shock absorber according to the echo signal, calculate a target current I′ of the respective shock absorber according to the vehicle wheel longitudinal acceleration signal and the vehicle body longitudinal acceleration signal, and regulate an input current of the respective shock absorber according to the reference current I and the target current I′.

In an exemplary embodiment, the MCU is configured to calculate, according to the echo signal, a depth of a depression or a height of a slope in front of the vehicle wheels in a driving direction of the vehicle, and then calculate the reference current I according to the depth of the depression or the height of the slope in front of the vehicle wheels and the time t needed by the respective vehicle wheel to reach the depression or the slope in front of the vehicle wheels.

The MCU is further configured to obtain the vehicle wheel longitudinal acceleration and the vehicle body longitudinal acceleration according to the vehicle wheel longitudinal acceleration signal and the vehicle body longitudinal acceleration signal, calculate the target current I′ according to the vehicle wheel longitudinal acceleration and the vehicle body longitudinal acceleration, and use a PI control algorithm to regulate the input current of the respective shock absorber according to the target current I′ and the reference current I, so as to regulate damping of the respective shock absorber.

The MCU is further configured to output the control instruction to the ultrasonic sensor, so as to control the set angle, according to which the ultrasonic sensor excites the ultrasonic wave, to change continuously.

The ultrasonic sensor is the phased array ultrasonic sensor.

In an exemplary embodiment, the device further includes the H-bridge module.

The H-bridge module is configured to generate a corresponding control current according to the pulse signal from the MCU, and transport the control current to the shock absorber, so as to regulate damping of the respective shock absorber.

The MCU is configured to calculate the current error according to the target current I′ and the control current, use the PI control algorithm to obtain the duty ratio according to the current error and the reference current I, and output the corresponding pulse signal to the H-bridge module according to the duty ratio.

In an exemplary embodiment, the device further includes the resistor and the voltage acquisition device.

The resistor is connected between the output end of the H-bridge module and the respective shock absorber in series.

The voltage acquisition device is connected to two ends of the resistor in parallel, is electrically connected with the MCU, and is configured to acquire the voltage signals of the two ends of the resistor, and transmit the voltage signals to the MCU.

The MCU is further configured to calculate the control current according to the voltage signals and a resistance value of the resistor.

In an exemplary embodiment, the MCU is configured to calculate the reference current I according to the following formula:

I=K1*h*|H|/t;

where K1 is a set coefficient, and 0<K1*h/t<20; and h is a height of a vehicle body.

In an exemplary embodiment, the MCU is configured to calculate the target current I′ according to the following formula:

I′=K2*Vb/(Vb−Vw);

where K2 is a scalar coefficient, and 0<K2<30; Vb is a longitudinal velocity of the vehicle body; Vw is a longitudinal velocity of a vehicle wheel; the Vb and the Vw are obtained by performing differentiation processing according to the vehicle body longitudinal acceleration and the vehicle wheel longitudinal acceleration.

In an exemplary embodiment, the MCU is configured to calculate the duty ratio according to the following formula:

PWM=Kp*(ΔI−ΔI′)+Ki*ΔI+I+PWM′;

where Kp is a proportionality coefficient, Ki is a differential coefficient, ΔI is the current error of a latter moment in adjacent two moments, ΔI′ is the current error of a previous moment in adjacent two moments, PWM is the duty ratio of the latter moment in adjacent two moments, PWM′ is the duty ratio of the previous moment in adjacent two moments, and 1<Kp<50, 0<Ki<0.5, and the duty ratio of an initial moment is 0.

Implementing the solution in the embodiments of the present disclosure has the following beneficial effects: an ultrasonic sensor excites an ultrasonic wave and receives the ultrasonic wave reflected by the road ahead; the received ultrasonic wave is converted into a corresponding echo signal; the echo signal is transmitted to an MCU; the MCU determines a road condition ahead in real time and calculates the reference current according to the echo signal; an acceleration sensor acquires a vehicle body longitudinal acceleration and a vehicle wheel longitudinal acceleration to calculate a target current of a shock absorber, a control current output to the shock absorber is controlled and regulated in advance, so that an input current of the shock absorber reaches the target current. In this way, the damping of the shock absorber is effectively changed in advance, the road condition ahead may be prejudged sufficiently, and the shock absorber may be automatically controlled, thereby reducing the shock impulses in a vehicle when the vehicle goes through a bumpy section of road ahead, and improving comfortableness and stationarity of driving and riding.

### BRIEF DESCRIPTION OF THE DRAWINGS

In order to more clearly illustrate technical solutions in embodiments of the present disclosure or the related art, the accompanying drawings needed in description of the embodiments or the related art are simply introduced below. It is apparent that the accompanying drawings in the following description are only some embodiments of the present disclosure, for the ordinary skill in the art, some other accompanying drawings can also be obtained according to these on the premise of not contributing creative effort.

FIG. 1 is a principle diagram of a device for controlling an active suspension provided by an embodiment of the present disclosure.

FIG. 2 is a principle diagram of the device for controlling the active suspension according to another embodiment of the present disclosure.

FIG. 3 is a flowchart of a method for controlling an active suspension provided by an embodiment of the present disclosure.

FIG. 4 is an installation diagram of a phased array ultrasonic sensor according to another embodiment of the present disclosure.

FIG. 5 is a principle diagram of calculating a depression ahead in a method for controlling an active suspension according to another embodiment of the present disclosure.

FIG. 6 is a principle diagram of calculating a slope ahead in the method for controlling an active suspension according to another embodiment of the present disclosure.

### DETAILED DESCRIPTION OF THE EMBODIMENTS

The description of embodiments below is used for illustrating, with reference to the accompanying drawings, specific embodiments of the present disclosure which may be implemented.

An embodiment of the present disclosure provides a device for controlling an active suspension. As illustrated in FIG. 1, the device for controlling the active suspension includes: an MCU 2, and an ultrasonic sensor 1, a vehicle body longitudinal acceleration sensor 3 and a vehicle body longitudinal acceleration sensor 4 which are respectively in communication connection with the MCU 2.

The vehicle wheel longitudinal acceleration signal 3 is set on a vehicle wheel, and is configured to acquire a vehicle wheel longitudinal acceleration signal, and transmit the vehicle wheel longitudinal acceleration signal to the MCU 2.

The vehicle wheel longitudinal acceleration signal 4 is set on a position of vehicle body above the vehicle wheel, and is configured to acquire a vehicle body longitudinal acceleration signal, and transmit the vehicle body longitudinal acceleration signal to the MCU 2.

The ultrasonic sensor 1 is set on a vehicle head in front of vehicle wheels, and is configured to excite an ultrasonic wave according to a set angle, and transmit a received echo signal to the MCU 2. The set angle is an included angle between the excited ultrasonic wave and a direction vertical to the ground. In an exemplary embodiment, there are two ultrasonic sensors 1. Both of the two ultrasonic sensors 1 are set on the vehicle head, for example, at two sides of the vehicle head separately.

The MCU 2 is electrically connected with a shock absorber 6 which is set between a vehicle wheel and a vehicle body, and is configured to calculate a reference current I of the shock absorber 6 according to the echo signal transmitted by the ultrasonic sensor 1, calculate a target current I′ of the shock absorber 6 according to the vehicle wheel longitudinal acceleration signal and the vehicle body longitudinal acceleration signal, and regulate an input current of the shock absorber 6 according to the reference current I and the target current I′. The damping of the shock absorber 6 may be regulated.

As an exemplary implementation, the ultrasonic sensor 1 excites the ultrasonic wave according to a set angle, herein the set angle uniformly changes according to a certain rate, and the range of change period of the set angle is from 5 milliseconds to 10 milliseconds. The angle is set in the range from 0 degree to 90 degrees. In a period, the set angle may gradually increase or gradually decrease.

When the vehicle wheel longitudinal acceleration sensor 3 is set on a certain vehicle wheel of the vehicle, the vehicle body longitudinal acceleration sensor 4 may be set on the vehicle body above this vehicle wheel, the ultrasonic sensor 1 is in front of this vehicle wheel, and the MCU 2 regulates the input current of the shock absorber 6 connected with this vehicle wheel. The number of the longitudinal acceleration sensors matches with the number of the vehicle wheels of the vehicle. For example, when there are four vehicle wheels of the vehicle, four pairs of longitudinal acceleration sensors may be selected. The vehicle wheel longitudinal acceleration sensors 3 in different pairs of longitudinal acceleration sensors are respectively set on different vehicle wheels, the vehicle body longitudinal acceleration sensors 4 are respectively set on the vehicle body above the respective vehicle wheels, and there are shock absorbers 6 set between respective vehicle wheels and the vehicle body of the vehicle. The damping of the different shock absorbers 6 may be regulated through the MCU 2.

Furthermore, the MCU 2 is configured to calculate, according to the echo signal transmitted by the ultrasonic sensor 1, a depth of a depression or a height of a slope in front of the vehicle wheel in a driving direction of the vehicle, and then calculate the reference current I according to the depth of the depression or the height of the slope in front of the vehicle wheel and the time t needed by the vehicle wheel to reach the depression or the slope in front of the vehicle wheel.

The MCU 2 is further configured to obtain a vehicle wheel longitudinal acceleration and a vehicle body longitudinal acceleration according to the vehicle wheel longitudinal acceleration signal and the vehicle body longitudinal acceleration signal, calculate the target current I′ according to the vehicle wheel longitudinal acceleration and the vehicle body longitudinal acceleration, and use a PI control algorithm to regulate the input current of the shock absorber 6 according to the target current I′ and the reference current I, so as to regulate damping of the shock absorber 6.

The MCU 2 is further configured to output a control instruction to the ultrasonic sensor 1, so as to control the set angle, according to which the ultrasonic sensor 1 excites the ultrasonic wave, to change continuously. The ultrasonic sensor is a phased array ultrasonic sensor.

Furthermore, the device for controlling the active suspension further includes an H-bridge module 5. An input end of the H-bridge module 5 is electrically connected with the MCU 2, and an output end is electrically connected with the shock absorber 6. The H-bridge module 5 is configured to generate a corresponding control current according to a pulse signal from the MCU 2, and transport the control current to the shock absorber 6, so as to regulate damping of the shock absorber 6.

The MCU 2 is configured to calculate a current error according to the target current I′ and the control current. The current error is a difference value between the target current I′ and the input current of the shock absorber 6. The MCU 2 is further configured to use, according to the current error and the reference current I, the PI control algorithm to obtain a duty ratio, and output, according to the duty ratio, the corresponding pulse signal to the H-bridge module 5.

Specifically, the pulse signals output by the MCU 2 according to the duty ratio are two voltage pulse signals, one of which is forward voltage pulse signal, and the other is reverse voltage pulse signal. The two voltage pulse signals are respectively input from two different bridge arms on the H-bridge module 5. The two voltage pulse signals have the same pulse width, the same signal period, the same amplitude, and opposite voltage directions.

Furthermore, the device for controlling the active suspension further includes a resistor (not illustrated in FIG. 1) and a voltage acquisition device (not illustrated in FIG. 1).

The resistor is connected between the output end of the H-bridge module 5 and the shock absorber 6 in series. The input current of the shock absorber 6 is as same as the current flowing through the resistor. The voltage acquisition device is connected to two ends of the resistor in parallel, is electrically connected with the MCU 2, and is configured to acquire voltage signals of the two ends of the resistor, and transmit the voltage signals to the MCU 2. A resistance value of the resistor adopted here is small, generally about 10 ohms.

The vehicle body longitudinal acceleration signal output by the vehicle body longitudinal acceleration sensor 4 is a longitudinal acceleration analog signal of vehicle body, the vehicle wheel longitudinal acceleration signal output by the vehicle wheel longitudinal acceleration sensor 3 is a longitudinal acceleration analog signal of vehicle wheel, and the voltage signal output by the voltage acquisition device is a voltage analog signal.

The MCU 2 is further configured to calculate a current value of the control current according to the voltage signal and the resistance value of the resistor. The MCU 2 includes: an Analog to Digital Converter (ADC) module 21, a Controller Area Network (CAN) module 22, a calculation control module 23, and a Pulse Width Modulation (PWM) module 24.

The CAN module 22 is in communication connection with the calculation control module 23, and is also in communication connection with a vehicle body control unit and the ultrasonic sensor 1 through a CAN bus. The CAN module 22 is configured to acquire a vehicle velocity V from the vehicle body control unit, and transmit the vehicle velocity V to the calculation control module 23. The CAN module 22 is further configured to receive the echo signal transmitted by the ultrasonic sensor 1 through the CAN bus, and transmit the echo signal to the calculation control module 23. The vehicle body control unit may obtain the vehicle velocity V according to a rotation speed of the vehicle wheel and a diameter of the vehicle wheel.

The PWM module 24 is electrically connected with the H-bridge module 5, and is configured to generate the corresponding pulse signal according to the duty ratio, and transmit the pulse signal to the H-bridge module 5. The PWM module 24 is namely the pulse width modulation module.

The ADC module 21 is in communication connection with the calculation control module 23, the voltage acquisition device, the vehicle body longitudinal acceleration sensor 4 and the vehicle wheel longitudinal acceleration sensor 3. The ADC module 21 is configured to receive the voltage analog signal output by the voltage acquisition device, the longitudinal acceleration analog signal of vehicle body output by the vehicle body longitudinal acceleration sensor 4, and the longitudinal acceleration analog signal of vehicle wheel output by the vehicle wheel longitudinal acceleration sensor 3, convert the voltage analog signal, the longitudinal acceleration analog signal of vehicle body and the longitudinal acceleration analog signal of vehicle wheel into corresponding voltage digital signal, vehicle body longitudinal acceleration digital signal and vehicle wheel longitudinal acceleration digital signal, and transmit the voltage digital signal, the vehicle body longitudinal acceleration digital signal and the vehicle wheel longitudinal acceleration digital signal to the calculation control module 23.

The calculation control module 23 is in communication connection with the PWM module 24. The calculation control module 23 is configured to obtain the corresponding vehicle wheel longitudinal acceleration and vehicle body longitudinal acceleration according to the vehicle wheel longitudinal acceleration digital signal and the vehicle body longitudinal acceleration digital signal, calculate the target current I′ of the shock absorber 6 according to the vehicle wheel longitudinal acceleration and the vehicle body longitudinal acceleration, calculate the current error according to the target current I′ of the shock absorber 6 and the control current output to the shock absorber 6, use, according to the current error and the reference current I, the PI control algorithm to calculate the duty ratio, and transmit the duty ratio to the PWM module 24. The calculation control module 23 is further configured to calculate a current value of the input current of the shock absorber 6 according to the voltage digital signal and the resistance value of the resistor.

Furthermore, the MCU 2 calculates the height of a slope ahead or the depth of a depression ahead according to the following formula:

S1=Vc*T1/2, S2=Vc*T2/2,

H=S2*cos(β)−S1*cos(α);

when β<α, if H>0, there is a slope ahead, and the height of the slope is H, if H<0, there is a depression ahead, and the depth of the depression is −H; when β>α, if H>0, there is a depression ahead, and the depth of the depression is H, if H<0, there is a slope ahead, and the height of the slope is −H;

where Vc is a propagation velocity of the ultrasonic wave, T1 is the time needed by receiving the echo signal after exciting the ultrasonic wave corresponding to the previous moment in adjacent two moments, and T2 is the time needed by receiving the echo signal after exciting the ultrasonic wave corresponding to the latter moment in adjacent two moments, here, the excited ultrasonic wave and the ultrasonic wave corresponding to receiving the echo signal are the same; α is the set angle corresponding to exciting the echo signal at the previous moment, and β is the set angle corresponding to exciting the echo signal at the latter moment.

Furthermore, the MCU 2 is in communication connection with the vehicle body control unit through the CAN bus, and is configured to acquire the vehicle velocity V from the vehicle body control unit, and calculate the time t needed by the vehicle wheel to reach the depression or slope ahead according to the following formula:

when β<α, t=(S1*sin(α)+S′)/V; when β>α, t=(S2*sin(β)+S′)/V, where S′ is a distance between projections of the vehicle wheel and the ultrasonic sensor 1 on the ground. In an exemplary embodiment, the MCU 2 calculates the reference current I according to the following formula:

I=K1*h*|H|/t; |H| is the absolute value of H;

where K1 is a set coefficient, and 0<K1*h/t<20, and h is a height of the vehicle body.

Furthermore, the MCU 2 calculates the target current I′ of the shock absorber 6 according to the following formula:

I′=K2*Vb/(Vb−Vw);

where K2 is a scalar coefficient, and 0<K2<30; Vb is a longitudinal velocity of the vehicle body; Vw is a longitudinal velocity of a vehicle wheel; the Vb and the Vw are obtained by performing differentiation processing according to the vehicle body longitudinal acceleration and the vehicle wheel longitudinal acceleration.

Further, the MCU 2 calculates the duty ratio according to the following formula:

PWM=Kp*(ΔI−ΔI′)+Ki*ΔI+I+PWM′;

where Kp is a proportionality coefficient, Ki is a differential coefficient, ΔI is the current error of a latter moment in adjacent two moments, ΔI′ is the current error of a previous moment in adjacent two moments, PWM is the duty ratio of the latter moment in adjacent two moments, PWM′ is the duty ratio of the previous moment in adjacent two moments, and 1<Kp<50, 0<Ki<0.5, and the duty ratio of an initial moment is 0.

In an exemplary embodiment, the device for controlling the active suspension further includes: a voltage converter, a reset circuit, and a crystal oscillation circuit.

The voltage converter is electrically connected with the MCU 2, and is configured to convert a voltage input from an external battery into a voltage required by the MCU 2, and provide the voltage required by the MCU 2 to the MCU 2.

The reset circuit is electrically connected with the MCU 2, and is configured to control the MCU to reset.

The crystal oscillation circuit is electrically connected with the MCU 2, and is configured to transmit a clock signal to the MCU 2.

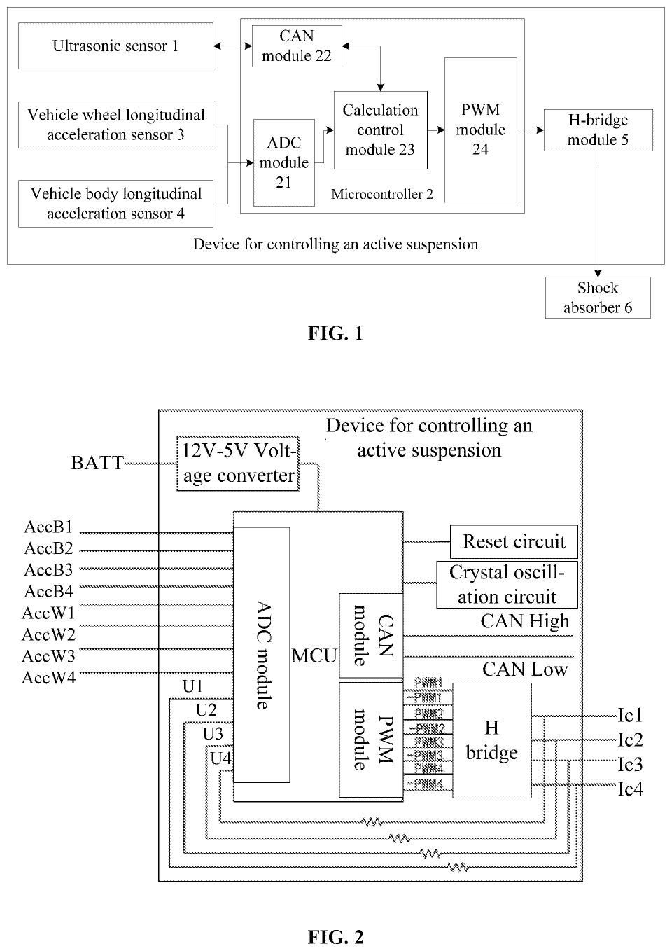

As illustrated in FIG. 2, in another embodiment of the device for controlling the active suspension provided by the present disclosure, an external pin BATT of the MCU represents an input of the battery, AccB1 represents the left front vehicle body longitudinal acceleration, AccB2 represents the right front vehicle body longitudinal acceleration, AccB3 represents the left rear vehicle body longitudinal acceleration, AccB4 represents the right rear vehicle body longitudinal acceleration, AccW1 represents the left front vehicle wheel longitudinal acceleration, AccW2 represents the right front vehicle wheel longitudinal acceleration, AccW3 represents the left rear vehicle wheel longitudinal acceleration, AccW4 represents the right rear vehicle wheel longitudinal acceleration, and CAN High and CAN Low represent two interfaces of the CAN.

The MCU is the core of the whole controller, completing logic operation control, in which the ADC module, the CAN module, and the PWM module must be included. The controller further needs the voltage converter converting 12V into 5V, the reset circuit, and the crystal oscillation circuit.

PWM1, −PWM1, PWM2, −PWM2, PWM3, −PWM3, PWM4 and −PWM4 are controlled by the PWM module. The currents of solenoid valves of four shock absorbers may be regulated by regulating the duty ratios of the pulse signals PWM1, −PWM1, PWM2, −PWM2, PWM3, −PWM3, PWM4 and −PWM4. The PWM1 and the −PWM1, the PWM2 and the −PWM2, the PWM3 and the −PWM3, the PWM4 and the −PWM4 are respectively forward pulse signal and reverse pulse signal.

U1, U2, U3 and U4 are respectively voltage signals of two ends of the resistors which are connected between the output end of the H-bridge module and the shock absorber in series. Ic1, Ic2, Ic3 and Ic4 are respectively currents output to the shock absorber.

CAN High and CAN low respectively represent two CAN buses of in-vehicle buses. An active suspension controller communicates with two phased array ultrasonic sensors and other nodes of the vehicle through the CAN bus.

Another embodiment of the present disclosure provides a system for controlling an active suspension. The system for controlling an active suspension includes the device for controlling the active suspension and a plurality of shock absorbers electrically connected with the device for controlling the active suspension. Each shock absorber is set between a vehicle body and a respective vehicle wheel, and two ends of each shock absorber are respectively connected with the vehicle wheel and the vehicle body.

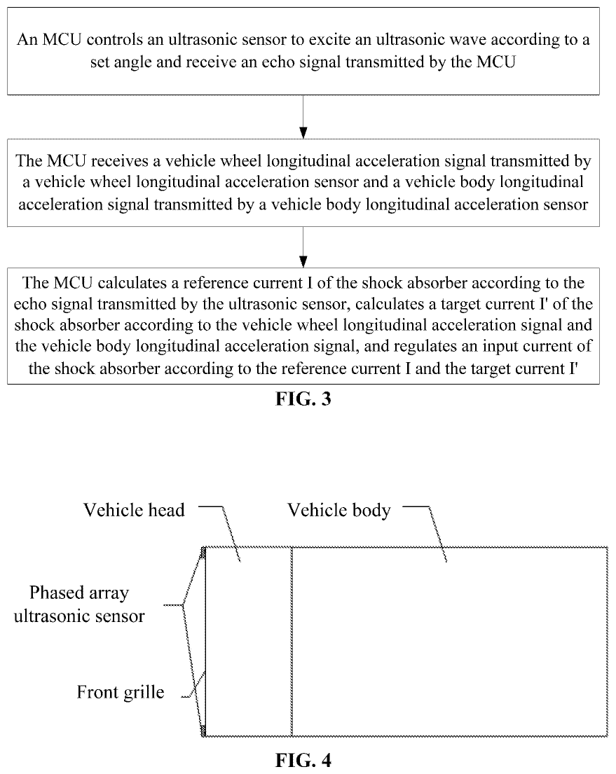

Another embodiment of the present disclosure provides a method for controlling an active suspension. As illustrated in FIG. 3, the method includes the following operations.

The MCU 2 controls the ultrasonic sensor 1 to excite the ultrasonic wave according to the set angle and receive the echo signal transmitted by the MCU 2, herein the set angle is the included angle between the excited ultrasonic wave and the direction vertical to the ground, and changes continuously.

The MCU 2 receives the vehicle wheel longitudinal acceleration signal transmitted by the vehicle wheel longitudinal acceleration sensor 3 and the vehicle body longitudinal acceleration signal transmitted by the vehicle body longitudinal acceleration sensor 4.

The MCU 2 calculates the reference current I of the shock absorber 6 according to the echo signal transmitted by the ultrasonic sensor 1, calculates the target current I′ of the shock absorber 6 according to the vehicle wheel longitudinal acceleration signal and the vehicle body longitudinal acceleration signal, and regulates the input current of the shock absorber 6 according to the reference current I and the target current I′.

Furthermore, the operation that the MCU 2 calculates the reference current I of the shock absorber 6 according to the echo signal transmitted by the ultrasonic sensor 1 includes:

the MCU 2 calculates according to the echo signal transmitted by the ultrasonic sensor 1, the depth of the depression or the height of the slope in front of the vehicle wheel in the driving direction of the vehicle, and then calculate the reference current I according to the depth of the depression or the height of the slope in front of the vehicle wheel and the time t needed by the vehicle wheel to reach the depression or the slope in front of the vehicle wheel.

The operations that the MCU 2 calculates the target current I′ of the shock absorber 6 according to the vehicle wheel longitudinal acceleration signal and the vehicle body longitudinal acceleration signal, and regulates the input current of the shock absorber 6 according to the reference current I and the target current I′ include:

the MCU 2 obtains the vehicle wheel longitudinal acceleration and the vehicle body longitudinal acceleration according to the vehicle wheel longitudinal acceleration signal and the vehicle body longitudinal acceleration signal, calculates the target current I′ according to the vehicle wheel longitudinal acceleration and the vehicle body longitudinal acceleration, and uses the PI control algorithm to regulate the input current of the shock absorber 6 according to the target current I′ and the reference current I, so as to regulate damping of the shock absorber 6.

Furthermore, the operation that the PI control algorithm is used to regulate the input current of the shock absorber 6 includes:

the MCU 2 calculates the current error according to the target current I′ and the control current output to the shock absorber 6, uses the PI control algorithm to obtain the duty ratio according to the current error and the reference current I, outputs the corresponding pulse signal to the H-bridge module 5 according to the duty ratio, controls the H-bridge module 5 to generate a corresponding control current, and outputs the control current to the shock absorber 6.

Furthermore, the MCU 2 calculates the height of the slope ahead or the depth of the depression ahead according to the following formula:

S1=Vc*T1/2, S2=Vc*T2/2,

H=S2*cos(β)−S1*cos(α);

when β<α, if H>0, there is a slope ahead, and the height of the slope is H, if H<0, there is a depression ahead, and the depth of the depression is −H; when β>α, if H>0, there is a depression ahead, and the depth of the depression is H, if H<0, there is a slope ahead, and the height of the slope is −H;

where Vc is the propagation velocity of the ultrasonic wave, T1 is the time needed by receiving the echo signal after exciting the ultrasonic wave corresponding to the previous moment in adjacent two moments, and T2 is the time needed by receiving the echo signal after exciting the ultrasonic wave corresponding to the latter moment in adjacent two moments, here, the excited ultrasonic wave and the ultrasonic wave corresponding to receiving the echo signal are the same; α is the set angle corresponding to exciting the echo signal at the previous moment, and β is the set angle corresponding to exciting the echo signal at the latter moment.

Furthermore, the method for controlling an active suspension further includes the following operations.

The MCU 2 acquires, through the CAN bus, the vehicle velocity V from the vehicle body control unit.

The MCU 2 calculates the time t needed by the vehicle wheel to reach the depression or slope ahead according to the following formula:

when β<α, t=(S1*sin(α)+S′)/V; when β>α, t=(S2*sin(β)+S′)/V, where S′ is a distance between projections of the vehicle wheel and the ultrasonic sensor 1 on the ground.

In an exemplary embodiment, the MCU 2 calculates the reference current I according to the following formula:

I=K1*h*|H|/t; |H| is the absolute value of H;

where K1 is a set coefficient, and 0<K1*h/t<20; and h is a height of a vehicle body; The MCU 2 calculates the target current I′ of the shock absorber 6 according to the following formula:

I′=K2*Vb/(Vb−Vw);

where K2 is a scalar coefficient, and 0<K2<30; Vb is a longitudinal velocity of the vehicle body; Vw is a longitudinal velocity of a vehicle wheel; the Vb and the Vw are obtained by performing differentiation processing according to the vehicle body longitudinal acceleration and the vehicle wheel longitudinal acceleration.

The MCU 2 calculates the duty ratio according to the following formula:

PWM=Kp*(ΔI−ΔI′)+Ki*ΔI+I+PWM′;

where Kp is a proportionality coefficient, Ki is a differential coefficient, ΔI is the current error of a latter moment in adjacent two moments, ΔI′ is the current error of a previous moment in adjacent two moments, PWM is the duty ratio of the latter moment in adjacent two moments, PWM′ is the duty ratio of the previous moment in adjacent two moments, and 1<Kp<50, 0<Ki<0.5, and the duty ratio of an initial moment is 0.

In another embodiment of the method for controlling an active suspension provided by the present disclosure, as illustrated in FIG. 14, there are two phased array ultrasonic sensors. Both the two phased array ultrasonic sensors are set on the vehicle head, for example, at two sides of the vehicle head separately.

The MCU excites the phased array ultrasonic sensor to send out the ultrasonic wave to detect the road condition ahead, and may calculates, according to a time difference between exciting the ultrasonic wave and receiving the returned ultrasonic wave each time, to obtain S1=Vc*T1/2, S2=Vc*T2/2, S1′=Vc*T1′/2, S2′=Vc*T2′/2, Vc=340, where T1 is the time difference between exciting the ultrasonic wave by the left phased array ultrasonic sensor corresponding to the previous moment in adjacent two moments and receiving the returned ultrasonic wave, T2 is the time difference between exciting the ultrasonic wave by the left phased array ultrasonic sensor corresponding to the latter moment in adjacent two moments and receiving the returned ultrasonic wave, T1′ is the time difference between exciting the ultrasonic wave by the right phased array ultrasonic sensor corresponding to the previous moment in adjacent two moments and receiving the returned ultrasonic wave, and T2′ is the time difference between exciting the ultrasonic wave by the right phased array ultrasonic sensor corresponding to the latter moment in adjacent two moments and receiving the returned ultrasonic wave.

By taking the left vehicle wheel of the vehicle for example, as illustrated in FIG. 5, when there are depressions on the road in front of the left vehicle wheel, α1 is the included angle between the ultrasonic wave excited by the left phased array ultrasonic sensor at the previous moment and the direction vertical to the ground, and β1 is the included angle between the ultrasonic wave excited by the left phased array ultrasonic sensor at the latter moment and the direction vertical to the ground, herein α1>β1. The depth of the depression ahead is H1, and H1=S1*cos(α1)−S2*cos(β1). At this point, the distance between the left front wheel and the depression ahead is S1*sin(α1)+S3, and the distance between the left rear wheel and the depression ahead is S1*sin(α1)+S3+S4, herein S3 is the distance between the projections of the left front wheel and the left phased array ultrasonic sensor on the ground, and S4 is the distance between the left front wheel and the left rear wheel. By that analogy, the depths of depression of all roads ahead may be obtained.

Similarly, the depth of the depression in front of the right front wheel is H2, and H2=S1′*cos(α2)−S2′*cos(β2), the distance between the right front wheel and the depression ahead is S1′*sin(α2)+S3, and the distance between the right rear wheel and the depression ahead is S1′*sin(α2)+S3+S4; herein, α2 is the included angle between the ultrasonic wave excited by the right phased array ultrasonic sensor at the previous moment and the direction vertical to the ground, and β2 is the included angle between the ultrasonic wave excited by the right phased array ultrasonic sensor at the latter moment and the direction vertical to the ground.

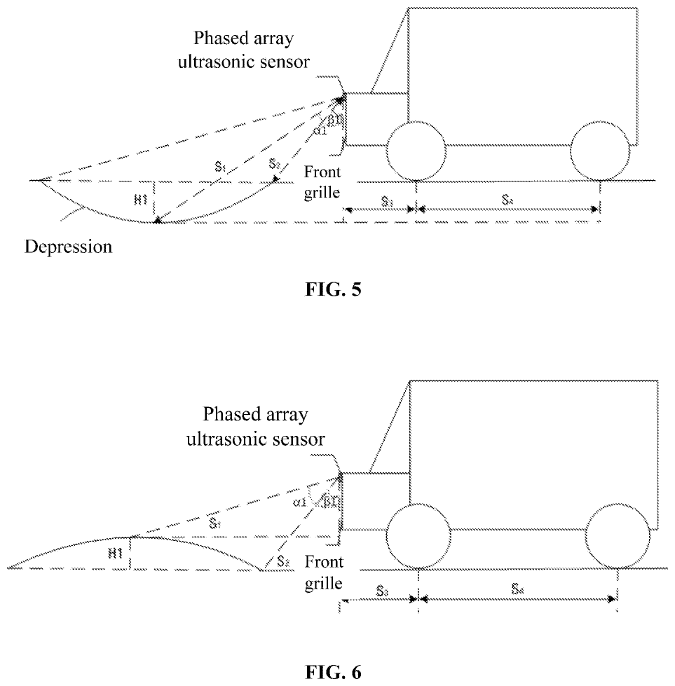

By taking the left vehicle wheel for example, when there are slopes on the road, as illustrated in FIG. 6, the height of the slope is H1′, and H1′=|S1*cos(α1)−S2*cos(β1)|, α1 is the included angle between the ultrasonic wave excited by the left phased array ultrasonic sensor at the previous moment and the direction vertical to the ground, and β1 is the included angle between the ultrasonic wave excited by the left phased array ultrasonic sensor at the latter moment and the direction vertical to the ground, herein α1>β1. At this point, the distance between the left front wheel and the slope ahead is S1*sin(α1)+S3, and the distance between the left rear wheel and the slope ahead is S1*sin(α1)+S3+S4. By that analogy, the depths of slope of all roads ahead may be obtained. Similarly, the depth of the slope in front of the right front wheel is H2, and H2′=|S1′*cos(α2)−S2′*cos(β2)|, the distance between the right front wheel and the slope ahead is S1′*sin(α2)+S3, and the distance between the right rear wheel and the slope ahead is S1′*sin(α2)+S3+S4; herein, α2 is the included angle between the ultrasonic wave excited by the right phased array ultrasonic sensor at the previous moment and the direction vertical to the ground, and β2 is the included angle between the ultrasonic wave excited by the right phased array ultrasonic sensor at the latter moment and the direction vertical to the ground.

To sum up, when S1*cos(α1)−S2*cos(β1)>0, there is a depression in front of the left front wheel, and the depth of the depression is H1, herein H1=S1*cos(α1)−S2*cos(β1); when S1*cos(α1)−S2*cos(β1)<0, there is a slope in front of the left front wheel, and the height of the slope is H1′, herein H1′=|S1*cos(α1)−S2*cos(β1)|.

When S1′*cos(α2)−S2′*cos(β2)>0, there is a depression in front of the right front wheel, and the depth of the depression is H2, herein H2=S1′*cos(α2)−S2′*cos(β2); when S1′*cos(α2)−S2′*cos(β2)<0, there is a slope in front of the right front wheel, and the height of the slope is H2, herein H2′=|S1′*cos(α2)−S2′*cos(β2)|.

The MCU acquires a vehicle velocity signal from the CAN bus to obtain the vehicle velocity V. The moments that the left front wheel, the right front wheel, the left rear wheel and the right rear wheel reach the bumpy section ahead are calculated as follows:

t1=[S1*sin(α1)+S3]/V,

t2=[S1′*sin(α2)+S3]/V,

t3=[S1*sin(α1)+S3+S4]/V, and

t4=[S1′*sin(α2)+S3+S4]/V.

The reference currents at the moments t1, t2, t3 and t4 of four shock absorbers which are correspondingly connected with the left front wheel, the right front wheel, the left rear wheel and the right rear wheel are as follows:

I1=K1*h*|S1*cos(α1)−S2*cos(β1)|/t1,

I2=K1*h*|S1′*cos(α2)−S2′*cos(β2)|/t2,

I3=K1*h*|S1*cos(α1)−S2*cos(β1)|/t3, and

I4=K1*h*|S1′*cos(α2)−S2′*cos(β2)|/t4.

When the vehicle passes by the depression or slope ahead, the MCU obtains, by acquiring four acceleration values of vehicle body and four acceleration values of vehicle wheel, the accelerations of the vehicle body and the vehicle wheel as follows: AccB1, AccB2, AccB3, AccB4, AccW1, AccW2, AccW3, and AccW4. By differentiating the acceleration, four velocities of vehicle body and four velocities of vehicle wheel may be obtained as follows: Vb1, Vb2, Vb3, Vb4, Vw1, Vw2, Vw3, and Vw4.

The target currents of four shock absorbers are obtained according to the velocity of vehicle body and the velocity of vehicle wheel as follows:

I1′=K2*Vb1/(Vb1−Vw1),

I2′=K2*Vb2/(Vb2−Vw2),

I3′=K2*Vb3/(Vb3−Vw3), and

I4′=K2*Vb4/(Vb4−Vw4).

If the MCU acquires four output currents, namely the input currents of the shock absorbers, which are respectively I1″, I2″, I3″, and I4″, the current errors are respectively ΔI1=I1′−I1″, ΔI2=I2′−I2″, ΔI3=I3′−I3″, and ΔI4=I4′−I4″.

If the current errors acquired by the MCU in the previous period are ΔI1′, ΔI2′, ΔI3′, and ΔI4′, the outputs of the solenoid valves of the four shock absorbers are respectively:

PWM1=Kp*(ΔI1−ΔI1′)+Ki*ΔI1+I1+PWM1′,

PWM2=Kp*(ΔI2−ΔI2′)+Ki*ΔI2+I2+PWM2′,

PWM3=Kp*(ΔI3−ΔI3′)+Ki*ΔI3+I3+PWM3′, and

PWM4=Kp*(ΔI4−ΔI4′)+Ki*ΔI4+I4+PWM4′;

herein, PWM1′, PWM2′, PWM3′, and PWM4′ are respectively the outputs of the solenoid valves in the previous period.

To sum up, the present disclosure provides a device, system and method for controlling an active suspension. The system is added with two phased array ultrasonic sensors, four vehicle body longitudinal acceleration sensors, four vehicle wheel longitudinal acceleration sensors, and four shock absorbers. The phased array ultrasonic sensor detects the road condition ahead in real time, the acceleration sensor acquires the vehicle body longitudinal acceleration and the vehicle wheel longitudinal acceleration, and calculates the target currents of the solenoid valves of the four shock absorbers, and a PI control is used to regulate a PWM signal to drive an H bridge, so that the control current output to the shock absorber reaches the target current, and the damping of the shock absorber is effectively changed in advance. The system may prejudge a road condition ahead, and automatically control a shock absorber, thereby reducing the shock impulses in a vehicle when the vehicle goes through a bumpy section of road ahead, and improving comfortableness and stationarity of driving and riding.

The above contents are further elaborations of the present disclosure made with reference to the specific preferred embodiments, but it should not be considered that the specific implementation of the present disclosure is limited to these elaborations. On the premise of not departing from the conception of the present disclosure, those ordinary skill in the art to which the present disclosure belongs may also make some simple deductions and replacements, which should fall within the scope of protection of the present disclosure.

What is claimed is:

1. A method for controlling an active suspension, comprising:
controlling an ultrasonic sensor (1) to excite an ultrasonic wave according to a set angle, and receiving an echo signal transmitted by the ultrasonic sensor (1), wherein the set angle changes continuously;
receiving a vehicle wheel longitudinal acceleration signal transmitted by a vehicle wheel longitudinal acceleration sensor (3) and a vehicle body longitudinal acceleration signal transmitted by a vehicle body longitudinal acceleration sensor (4);
calculating a reference current I of a shock absorber (6) according to the echo signal transmitted by the ultrasonic sensor (1), calculating a target current I′ of the shock absorber (6) according to the vehicle wheel longitudinal acceleration signal and the vehicle body longitudinal acceleration signal, and regulating an input current of the shock absorber (6) according to the reference current I and the target current I′.

2. The method for controlling an active suspension as claimed in claim 1, wherein
calculating the reference current I of the shock absorber (6) according to the echo signal transmitted by the ultrasonic sensor (1) comprises:
calculating, according to the echo signal, a depth of a depression or a height of a slope in front of a vehicle wheel in a driving direction of a vehicle, and then calculating the reference current I according to the depth of the depression or the height of the slope in front of the vehicle wheel and time t needed by the vehicle wheel to reach the depression or the slope in front of the vehicle wheel;
calculating the target current I′ of the shock absorber (6) according to the vehicle wheel longitudinal acceleration signal and the vehicle body longitudinal acceleration signal, and regulating the input current of the shock absorber (6) according to the reference current I and the target current I′ comprises:
obtaining a vehicle wheel longitudinal acceleration and a vehicle body longitudinal acceleration according to the vehicle wheel longitudinal acceleration signal and the vehicle body longitudinal acceleration signal, calculating the target current I′ according to the vehicle wheel longitudinal acceleration and the vehicle body longitudinal acceleration, and using a PI control algorithm to regulate the input current of the shock absorber (6) according to the target current I′ and the reference current I, so as to regulate damping of the shock absorber (6).

3. The method for controlling an active suspension as claimed in claim 2, wherein using the PI control algorithm to regulate the input current of the shock absorber (6) comprises:
calculating a current error according to the target current I′ and a control current output to the shock absorber (6), using the PI control algorithm to obtain a duty ratio according to the current error and the reference current I, outputting a corresponding pulse signal to an H-bridge module (5) according to the duty ratio to control the H-bridge module (5) to generate a corresponding control current, and transport the control current to the shock absorber (6).

4. The method for controlling an active suspension as claimed in claim 1, wherein the reference current I is calculated according to the following formula:
I=K1*h*|H|/t;
where K1 is a set coefficient, and 0<K1*h/t<20; and h is a height of a vehicle body.

5. The method for controlling an active suspension as claimed in claim 4, wherein the duty ratio is calculated according to the following formula:
PWM=Kp*(ΔI−ΔI′)+Ki*ΔI+I+PWM′;
where Kp is a proportionality coefficient, Ki is a differential coefficient, ΔI is the current error of a latter moment in adjacent two moments, ΔI′ is the current error of a previous moment in adjacent two moments, PWM is the duty ratio of the latter moment in adjacent two moments, PWM′ is the duty ratio of the previous moment in adjacent two moments, and 1<Kp<50, 0<Ki<0.5, and the duty ratio of an initial moment is 0.

6. A device for controlling an active suspension, comprising: a Micro Control Unit (MCU) (2), an ultrasonic sensor (1), a vehicle wheel longitudinal acceleration sensor (3) and a vehicle body longitudinal acceleration sensor (4); wherein
the vehicle wheel longitudinal acceleration signal (3) is configured to acquire a vehicle wheel longitudinal acceleration signal, and transmit the vehicle wheel longitudinal acceleration signal to the MCU (2);
the vehicle body longitudinal acceleration signal (4) is configured to acquire a vehicle body longitudinal acceleration signal, and transmit the vehicle body longitudinal acceleration signal to the MCU (2);
the ultrasonic sensor (1) is set on a vehicle head in front of vehicle wheels, and is configured to excite an ultrasonic wave according to a set angle, and transmit a received echo signal to the MCU (2);
the MCU (2) is electrically connected with a shock absorber (6) which is set between a vehicle wheel and a vehicle body, and is configured to calculate a reference current I of the shock absorber (6) according to the echo signal, calculate a target current I′ of the shock absorber (6) according to the vehicle wheel longitudinal acceleration signal and the vehicle body longitudinal acceleration signal, and regulate an input current of the shock absorber (6) according to the reference current I and the target current I′.

7. The device for controlling the active suspension as claimed in claim 6, wherein
the MCU (2) is configured to calculate, according to the echo signal, a depth of a depression or a height of a slope in front of the vehicle wheel in a driving direction of a vehicle, and then calculate the reference current I according to the depth of the depression or the height of the slope in front of the vehicle wheel and time t needed by the vehicle wheel to reach the depression or the slope in front of the vehicle wheel;
the MCU (2) is further configured to obtain a vehicle wheel longitudinal acceleration and a vehicle body longitudinal acceleration according to the vehicle wheel longitudinal acceleration signal and the vehicle body longitudinal acceleration signal, calculate the target current I′ according to the vehicle wheel longitudinal acceleration and the vehicle body longitudinal acceleration, and use a PI control algorithm to regulate the input current of the shock absorber (6) according to the target current I′ and the reference current I, so as to regulate damping of the shock absorber (6);
the MCU (2) is further configured to output a control instruction to the ultrasonic sensor (1), so as to control the set angle, according to which the ultrasonic sensor (1) excites the ultrasonic wave, to change continuously;
the ultrasonic sensor (1) is a phased array ultrasonic sensor.

8. The device for controlling the active suspension as claimed in claim 7, further comprising an H-bridge module (5);
the H-bridge module (5) is configured to generate a corresponding control current according to a pulse signal from the MCU (2), and transport the control current to the shock absorber (6), so as to regulate damping of the shock absorber (6);
the MCU (2) is configured to calculate a current error according to the target current I′ and the control current, use the PI control algorithm to obtain a duty ratio according to the current error and the reference current I, and output a corresponding pulse signal to the H-bridge module (5) according to the duty ratio.

9. The device for controlling the active suspension as claimed in claim 8, further comprising a resistor and a voltage acquisition device;
the resistor is connected between an output end of the H-bridge module (5) and the shock absorber (6) in series;
the voltage acquisition device is connected to two ends of the resistor in parallel, is electrically connected with the MCU (2), and is configured to acquire voltage signals of the two ends of the resistor, and transmit the voltage signals to the MCU (2);
the MCU (2) is further configured to calculate the control current according to the voltage signals and a resistance value of the resistor.

10. The device for controlling the active suspension as claimed in claim 6, wherein the MCU (2) is configured to calculate the reference current I according to the following formula:
I=K1*h*|H|/t;
where K1 is a set coefficient, and 0<K1*h/t<20, and h is a height of the vehicle body.

11. The device for controlling the active suspension as claimed in claim 10, wherein the MCU (2) is configured to calculate the target current I′ according to the following formula:
I′=K2*Vb/(Vb−Vw);
where K2 is a scalar coefficient, and 0<K2<30; Vb is a longitudinal velocity of the vehicle body; Vw is a longitudinal velocity of a vehicle wheel; the Vb and the Vw are obtained by performing differentiation processing according to the vehicle body longitudinal acceleration and the vehicle wheel longitudinal acceleration.

12. The device for controlling the active suspension as claimed in claim 11, wherein the MCU (2) is configured to calculate the duty ratio according to the following formula:
PWM=Kp*(ΔI−ΔI′)+Ki*ΔI+I+PWM′;
where Kp is a proportionality coefficient, Ki is a differential coefficient, ΔI is the current error of a latter moment in adjacent two moments, ΔI′ is the current error of a previous moment in adjacent two moments, PWM is the duty ratio of the latter moment in adjacent two moments, PWM′ is the duty ratio of the previous moment in adjacent two moments, and 1<Kp<50, 0<Ki<0.5, and the duty ratio of an initial moment is 0.

13. A system for controlling an active suspension, comprising: a device for controlling an active suspension and a plurality of shock absorbers (6) electrically connected with the device for controlling the active suspension; each of the plurality of shock absorbers (6) is set between a vehicle body and a respective vehicle wheel;
the device for controlling the active suspension comprises: a Micro Control Unit (MCU) (2), an ultrasonic sensor (1), a vehicle wheel longitudinal acceleration sensor (3) and a vehicle body longitudinal acceleration sensor (4); wherein
the vehicle wheel longitudinal acceleration signal (3) is configured to acquire a vehicle wheel longitudinal acceleration signal, and transmit the vehicle wheel longitudinal acceleration signal to the MCU (2);
the vehicle body longitudinal acceleration signal (4) is configured to acquire a vehicle body longitudinal acceleration signal, and transmit the vehicle body longitudinal acceleration signal to the MCU (2);
the ultrasonic sensor (1) is set on a vehicle head in front of vehicle wheels, and is configured to excite an ultrasonic wave according to a set angle, and transmit a received echo signal to the MCU (2);
the MCU (2) is electrically connected with each of the plurality of shock absorbers (6) which is set between the vehicle body and the respective vehicle wheel, and is configured to calculate a reference current I of a respective shock absorber (6) according to the echo signal, calculate a target current I′ of the respective shock absorber (6) according to the vehicle wheel longitudinal acceleration signal and the vehicle body longitudinal acceleration signal, and regulate an input current of the respective shock absorber (6) according to the reference current I and the target current I′.

14. The system for controlling an active suspension as claimed in claim 13, wherein
the MCU (2) is configured to calculate, according to the echo signal, a depth of a depression or a height of a slope in front of the vehicle wheels in a driving direction of a vehicle, and then calculate the reference current I according to the depth of the depression or the height of the slope in front of the vehicle wheels and time t needed by the respective vehicle wheel to reach the depression or the slope in front of the vehicle wheels; the MCU (2) is further configured to obtain a vehicle wheel longitudinal acceleration and a vehicle body longitudinal acceleration according to the vehicle wheel longitudinal acceleration signal and the vehicle body longitudinal acceleration signal, calculate the target current I′ according to the vehicle wheel longitudinal acceleration and the vehicle body longitudinal acceleration, and use a PI control algorithm to regulate the input current of the respective shock absorber (6) according to the target current I′ and the reference current I, so as to regulate damping of the respective shock absorber (6);
the MCU (2) is further configured to output a control instruction to the ultrasonic sensor (1), so as to control the set angle, according to which the ultrasonic sensor (1) excites the ultrasonic wave, to change continuously;
the ultrasonic sensor is a phased array ultrasonic sensor.

15. The system for controlling an active suspension as claimed in claim 14, further comprising an H-bridge module (5);
the H-bridge module (5) is configured to generate a corresponding control current according to a pulse signal from the MCU (2), and transport the control current to the respective shock absorber (6), so as to regulate damping of the respective shock absorber (6);
the MCU (2) is configured to calculate a current error according to the target current I′ and the control current, use the PI control algorithm to obtain a duty ratio according to the current error and the reference current I, and output a corresponding pulse signal to the H-bridge module (5) according to the duty ratio.

16. The system for controlling an active suspension as claimed in claim 15, further comprising a resistor and a voltage acquisition device;
the resistor is serially connected between an output end of the H-bridge module (5) and the respective shock absorber (6);
the voltage acquisition device is connected to two ends of the resistor in parallel, is electrically connected with the MCU (2), and is configured to acquire voltage signals of the two ends of the resistor, and transmit the voltage signals to the MCU (2);
the MCU (2) is further configured to calculate the control current according to the voltage signals and a resistance value of the resistor.

17. The system for controlling an active suspension as claimed in claim 13, wherein the MCU (2) is configured to calculate the reference current I according to the following formula:
I=K1*h*|H|/t;
where K1 is a set coefficient, and 0<K1*h/t<20, and h is a height of the vehicle body;
the MCU (2) is configured to calculate the target current I′ according to the following formula:
I′=K2*Vb/(Vb−Vw);
where K2 is a scalar coefficient, and 0<K2<30; Vb is a longitudinal velocity of the vehicle body, Vw is a longitudinal velocity of a vehicle wheel; the Vb and the Vw are obtained by performing differentiation processing according to the vehicle body longitudinal acceleration and the vehicle wheel longitudinal acceleration.

18. The system for controlling an active suspension as claimed in claim 17, wherein the MCU (2) is configured to calculate the duty ratio according to the following formula:
PWM=Kp*(ΔI−ΔI′)+Ki*ΔI+I+PWM′;
where Kp is a proportionality coefficient, Ki is a differential coefficient, ΔI is the current error of a latter moment in adjacent two moments, ΔI′ is the current error of a previous moment in adjacent two moments, PWM is the duty ratio of the latter moment in adjacent two moments, PWM′ is the duty ratio of the previous moment in adjacent two moments, and 1<Kp<50, 0<Ki<0.5, and the duty ratio of an initial moment is 0.

19. The method for controlling the active suspension as claimed in claim 3, wherein the control current is calculated in a following manner:
acquiring voltage signals of two ends of a resistor which is connected between an output end of the H-bridge module (5) and the shock absorber (6) in series;
calculating the control current according to the voltage signals and a resistance value of the resistor.

20. The method for controlling an active suspension as claimed in claim 1, wherein the target current I′ is calculated according to the following formula:
I′=K2*Vb/(Vb−Vw);
where K2 is a scalar coefficient, and 0<K2<30; Vb is a longitudinal velocity of the vehicle body; Vw is a longitudinal velocity of a vehicle wheel; the Vb and the Vw are obtained by performing differentiation processing according to the vehicle body longitudinal acceleration and the vehicle wheel longitudinal acceleration.
